(19) United States
(12) Patent Application Publication
(10) Pub. No.: US 2026/0109180 A1
(43) Pub. Date: Apr. 23, 2026

(54) TIRE, AND METHOD FOR MANUFACTURING SAME

(71) Applicant: THE YOKOHAMA RUBBER CO., LTD., Kanagawa (JP)

(72) Inventor: Masahiro NARUSE, Kanagawa (JP)

(21) Appl. No.: 19/159,088

(22) PCT Filed: Dec. 15, 2023
(86) PCT No.: PCT/JP2023/045037

§ 371 Date: Aug. 22, 2025

(30) Foreign Application Priority Data
Feb. 27, 2023 (JP) 2023-028428

(51) Int. Cl. B60C 15/06; B29D 30/06; B60C 11/03; B60C 19/00

(52) U.S. Cl. CPC B60C 15/06; B29D 30/0601; B60C 19/00; B60C 2011/0355

(57) ABSTRACT

A tire includes: a tread portion extending in a tire circumferential direction and having an annular shape; a pair of sidewall portions respectively disposed on both sides of the tread portion; and a pair of bead portions each disposed on an inner side of the sidewall portions in a tire radial direction; a carcass layer mounted between the pair of bead portions; a plurality of belt layers disposed on an outer circumferential side of the carcass layer in the tread portion; and an innerliner layer disposed on a tire inner surface along the carcass layer. In the tire, a plurality of ridges are formed at intervals on the tire inner surface, a transponder covered with a coating layer made of rubber is embedded inside the tire, and a center position of an IC chip constituting the transponder disposed in a region between the ridges adjacent each other.

### TECHNICAL FIELD

The present technology relates to a tire and a method for manufacturing the same and particularly relates to a tire that can provide a reduced rubber flow of a coating layer of a transponder during vulcanization and improved communication performance of the transponder and a method for manufacturing the same.

### BACKGROUND ART

For tires, embedding an RFID (radio frequency identification) tag (transponder) inside a tire has been proposed (see, for example, Japan Unexamined Patent Publication No. H07-137510 A).

To discharge air between a tire inner surface and a bladder to be used in vulcanizing a green tire to the outside, a plurality of exhaust grooves (recessed portions) are provided on an outer surface of the bladder (see, for example, Japan Unexamined Patent Publication No. 2014-084007 A). Thus, a plurality of protruding portions corresponding to the recessed portions of the outer surface of the bladder are formed on an inner surface of the vulcanized tire. If a transponder (especially an IC (integrated circuit) chip) covered with rubber and the exhaust groove of the bladder are disposed so as to overlap each other in embedding the transponder in a tire including such protruding portions, the coating rubber may be affected by the rubber flowing into the exhaust groove of the bladder, failing to cover the entire transponder. This causes a problem such as degradation in communication performance of the transponder.

### SUMMARY

The present technology provides a tire that can provide a reduced rubber flow of a coating layer of a transponder during vulcanization and improved communication performance of the transponder and a method for manufacturing the same.

A tire according to an embodiment of the present technology includes:
a tread portion extending in a tire circumferential direction and having an annular shape;
a pair of sidewall portions respectively disposed on both sides of the tread portion;
a pair of bead portions each disposed on an inner side of the sidewall portions in a tire radial direction;
a carcass layer being mounted between the pair of bead portions;
a plurality of belt layers being disposed on an outer circumferential side of the carcass layer in the tread portion; and
an innerliner layer being disposed on a tire inner surface along the carcass layer.

In the tire, a plurality of ridges are formed at intervals on the tire inner surface, a transponder covered with a coating layer made of rubber is embedded inside the tire, and a center position of an IC chip constituting the transponder is disposed in a region between the ridges adjacent to each other.

A method of manufacturing a tire according to an embodiment of the present technology is a method for manufacturing a tire including:
forming a green tire in which a transponder covered with rubber is embedded between tire components;
vulcanizing the green tire by using a bladder including a plurality of exhaust grooves on an outer surface thereof; and
causing a plurality of ridges to be formed on an inner surface of the green tire by the bladder.

The method includes, in embedding the transponder, embedding the transponder in the green tire such that a center position of an IC chip constituting the transponder is disposed in a region between the ridges adjacent to each other of the plurality of ridges.

In an embodiment of the present technology, a plurality of ridges are formed at intervals on the tire inner surface, a transponder covered with a coating layer made of rubber is embedded inside the tire, and a center position of an IC chip constituting the transponder is disposed in a region between the ridges adjacent to each other. Since the IC chip is the thickest portion in the transponder, the IC chip is particularly likely to be affected by the rubber flow around the transponder during vulcanization. Therefore, an embodiment of the present technology can reduce, by disposing the center position of the IC chip and the exhaust groove on the outer surface of the bladder in the green tire so that they do not overlap each other, the rubber flow of the coating layer covering the transponder during tire vulcanization, allowing the rubber of the coating layer to sufficiently cover the entire transponder. This can prevent problems such as degradation of the communication performance of the transponder, leading to reduction of vulcanization defects of the tire.

In the tire of an embodiment of the present technology, a mutual distance between the plurality of ridges preferably ranges from 3 mm to 50 mm. Appropriately setting the mutual distance d between the ridges while reducing the rubber flow of the coating layer by devising an arrangement position of the transponder can improve the effect of discharging air between the tire inner surface and the bladder during tire vulcanization.

On a tire inner circumference in a position in a tire radial direction where the transponder is disposed, an inclination angle θ of the ridges with respect to a tire circumferential direction preferably ranges from 20° to 60°. Appropriately setting the inclination angle of the ridges while reducing the rubber flow of the coating layer by devising an arrangement position of the transponder can improve the effect of discharging air between the tire inner surface and the bladder during tire vulcanization.

On the tire inner circumference in the position in the tire radial direction where the transponder is disposed, an average rubber thickness Ti from the tire inner surface to a carcass cord constituting the carcass layer and a height Tb of the ridges preferably satisfy a relationship 0.2≤Tb/Ti≤3.0. By satisfying the above-described relationship while suppressing the rubber flow of the coating layer by devising an arrangement position of the transponder, it is possible to improve the effect of discharging air between the tire inner surface and the bladder during tire vulcanization.

The height Tb of the ridges preferably ranges from 0.3 mm to 1.5 mm. Appropriately setting the height Tb of the ridges while reducing the rubber flow of the coating layer by devising an arrangement position of the transponder can improve the effect of discharging air between the tire inner surface and the bladder during tire vulcanization.

The transponder is preferably embedded between a position 5 mm inner side in the tire radial direction from an end of a belt layer having the widest belt width of the plurality of belt layers and a position 15 mm outer side in the tire radial direction from an upper end of a bead core of the bead portion and in a position where a total thickness Ga of the sidewall portion measured along a normal line direction of the carcass layer is in a range from 60% to 300% of a total thickness Gsw of the sidewall portion at a tire maximum width position. Disposing the transponder as described above causes the transponder to be positioned separated from tire components made of metal (for example, the bead core, the rim, or the like). This causes metal interference to be unlikely to occur and allows the communication performance of the transponder to be sufficiently ensured.

The transponder is preferably disposed between the innerliner layer and the carcass layer. Disposing the transponder as described above can prevent the transponder from being damaged due to damage of the sidewall portion.

The total thickness Gac of the coating layer and the maximum thickness Gar of the transponder preferably satisfy the relationship 1.1≤Gac/Gar≤3.0. This can sufficiently ensure the total thickness Gac of the coating layer, allowing the rubber flow of the coating layer during the tire vulcanization to be effectively reduced.

The total thickness Gac of the coating layer preferably ranges from 1% to 30% of a tire total thickness Gt at the embedded position of the transponder. This can appropriately set the total thickness Gac of the coating layer with respect to the tire total thickness Gt, allowing the rubber flow of the coating layer to be effectively reduced during tire vulcanization.

The coating layer preferably contains 20 phr or less of carbon black. This allows the relative dielectric constant of the coating layer to be reduced, allowing the communication performance of the transponder to be improved.

A viscosity v1 of the coating layer and a viscosity v2 of a rubber member disposed adjacent to the coating layer on an inner side in the tire width direction preferably satisfy a relationship 0.5<v1/v2<1.5. This can effectively reduce the rubber flow of the coating layer during tire vulcanization and obtain a further effect of reducing vulcanization defects.

### BRIEF DESCRIPTION OF DRAWINGS

FIG. 1 is a meridian cross-sectional view illustrating an example of a pneumatic tire according to an embodiment of the present technology.

FIG. 2A is an explanatory diagram illustrating an enlarged tire inner surface of FIG. 1, and FIG. 2B is a cross-sectional view taken along the line X-X of FIG. 2A.

FIGS. 3A and 3B are perspective views illustrating a transponder that can be embedded in the pneumatic tire according to the present technology.

FIG. 3A is a perspective view, and FIG. 3B is a cross-sectional view.

FIG. 4 is a half cross-sectional view taken along a meridian of a position where a transponder is disposed in the pneumatic tire according to an embodiment of the present technology.

FIG. 5 is a cross-sectional view illustrating a transponder covered with a coating layer and embedded in the pneumatic tire.

FIG. 6 is a cross-sectional view of a modified example of the pneumatic tire according to the embodiment of the present technology.

### DETAILED DESCRIPTION

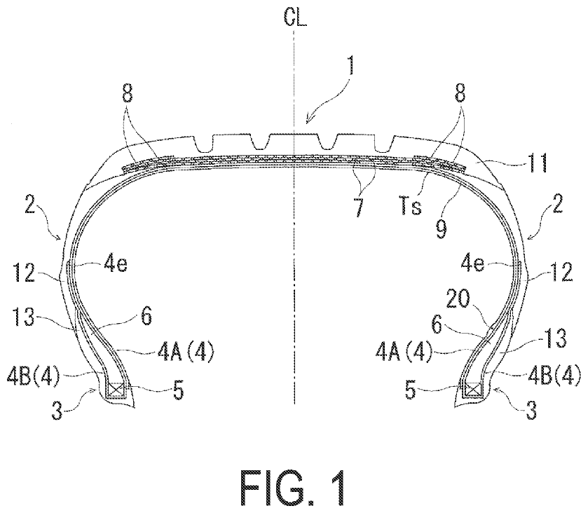

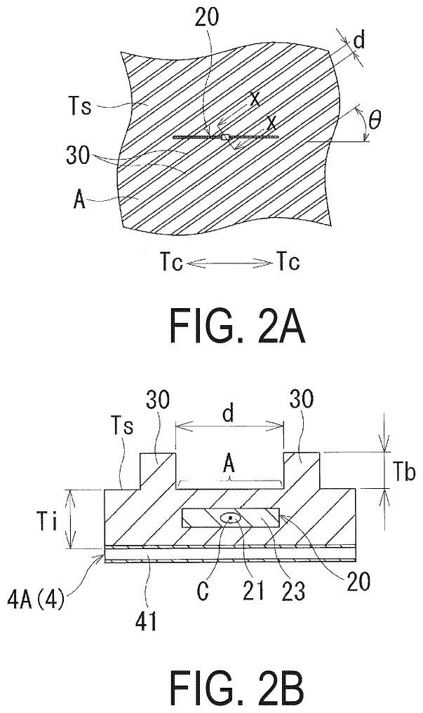

Configurations of embodiments of the present technology will be described in detail below with reference to the accompanying drawings. FIGS. 1 and 2 illustrate a pneumatic tire according to an embodiment of the present technology.

As illustrated in FIG. 1, the pneumatic tire according to the present embodiment includes a tread portion 1 extending in a tire circumferential direction and having an annular shape, a pair of sidewall portions 2 disposed on respective both sides of the tread portion 1, and a pair of bead portions 3 respectively disposed on inner sides of the pair of sidewall portions 2 in a tire radial direction.

At least one carcass layer 4 (one layer in FIG. 1) formed by arranging a plurality of carcass cords in the radial direction is mounted between the pair of bead portions 3. Organic fiber cords such as nylon and polyester are preferably used as the carcass cord constituting the carcass layer 4. Bead cores 5 having an annular shape are embedded within the bead portions 3, and bead fillers 6 made of a rubber composition and having a triangular cross-section are disposed on the outer peripheries of the bead cores 5. In addition, an innerliner layer 9 is disposed in an area between the pair of bead portions 3 on a tire inner surface Ts. The innerliner layer 9 forms the tire inner surface Ts.

As illustrated in FIGS. 2A and 2B, on the tire inner surface Ts, a plurality of ridges 30 protruding to the inner side in the tire radial direction from the tire inner surface Ts are formed in parallel with each other at intervals. These ridges 30 are formed on an inner surface of a green tire during tire vulcanization by exhaust grooves extending in the radial direction on an outer surface of the bladder.

On the other hand, a plurality of belt layers 7 (two layers in FIG. 1) are embedded on a tire outer circumferential side of the carcass layer 4 of the tread portion 1. The belt layers 7 include a plurality of reinforcing cords that are inclined with respect to the tire circumferential direction, and the reinforcing cords are disposed between layers so as to intersect each other. In the belt layers 7, the inclination angle of the reinforcing cords with respect to the tire circumferential direction is set to fall in a range from 10′ to 40°, for example. Steel cords are preferably used as the reinforcing cords of the belt layers 7.

To improve high-speed durability, at least one belt cover layer 8 (two layers in FIG. 1) formed by arranging reinforcing cords at an angle of, for example, 5° or less with respect to the tire circumferential direction is disposed on a tire outer circumferential side of the belt layers 7. In FIG. 1, the belt cover layer 8 located on the inner side in the tire radial direction constitutes a full cover that covers the entire width of the belt layers 7, and the belt cover layer 8 located on an outer side in the tire radial direction constitutes an edge cover layer that covers only end portions of the belt layers 7. Organic fiber cords such as nylon and aramid are preferably used as the reinforcing cords of the belt cover layer 8.

In the pneumatic tire described above, both ends 4e of the carcass layer 4 are folded back from the tire inner side to the tire outer side around the bead cores 5 and are disposed wrapping around the bead cores 5 and the bead fillers 6. The carcass layer 4 includes a body portion 4A corresponding to a portion extending from the tread portion 1 through each of the sidewall portions 2 to each of the bead portions 3 and a turned-up portion 4B corresponding to a portion turned up around the bead core 5 at each of the bead portions 3 and extending toward each sidewall portion 2 side.

A cap tread rubber layer 11 is disposed in the tread portion 1, a sidewall rubber layer 12 is disposed in the sidewall portion 2, and a rim cushion rubber layer 13 is disposed in the bead portion 3.

A transponder 20 is embedded inside such a pneumatic tire. In this embodiment, the transponder 20 is disposed between the carcass layer 4 and the innerliner layer 9 in a tire thickness direction. The transponder 20 is embedded inside the tire and thus cannot be visually recognized from the tire inner surface Ts. However, when the transponder 20 is projected onto the tire inner surface Ts, as illustrated in FIGS. 2A and 2B, a position of a center C of the IC chip 21 constituting the transponder 20 is disposed in a smooth region A between the ridges 30 adjacent to each other. In particular, the entire IC chip 21 is preferably disposed in the smooth region A.

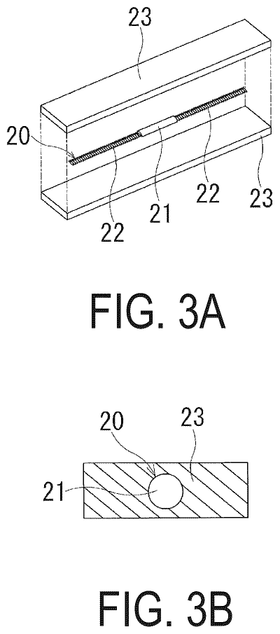

As illustrated in FIGS. 3A and 3B, the transponder 20 is covered with a coating layer 23 made of rubber. The coating layer 23 coats the entire transponder 20 while sandwiching both top and back surfaces of the transponder 20. The transponder 20 is protected by the coating layer 23 as described above, and thus the durability of the transponder 20 can be improved.

As the transponder 20, for example, a radio frequency identification (RFID) tag can be used. As illustrated in FIGS. 3A and 3B, the transponder 20 includes an IC chip 21 that stores data and antennas 22 that transmit and receive data in a non-contact manner. Using the transponder 20 such as that described above allows information related to the tire to be written or read on a timely basis and the tire to be efficiently managed. Here, “RFID” refers to an automatic recognition technology including: a reader/writer including an antenna and a controller, and an ID (identification) tag including an IC chip and an antenna, the automatic recognition technology allowing data to be communicated in a wireless manner.

The overall shape of the transponder 20 is not particularly limited, but using the transponder 20 having a pillar-like shape illustrated in FIG. 3A can suitably follow the deformation of the tire in each direction. In this case, the antenna 22 of the transponder 20 projects from each of both end portions of the IC chip 21 and exhibits a helical shape. This allows the transponder 20 to follow the deformation of the tire during traveling, allowing the durability of the transponder 20 to be improved. Further, the antenna 22 having a helical shape has an effect of reducing the rubber flow of the coating layer 23 due to its shape.

Next, a method for producing a pneumatic tire according to an embodiment of the present technology will be described. When a pneumatic tire in which the above-described transponder 20 is embedded is manufactured, various tire components are layered on a forming drum, the transponder 20 covered with rubber is embedded between the layers of the tire components, and the formed green tire is vulcanized using a bladder including a plurality of exhaust grooves on an outer surface thereof. Thus, the plurality of ridges 30 are formed on the inner surface of the green tire by the bladder.

In such a manufacturing process, when the transponder 20 is embedded, the transponder 20 is embedded such that the center C of the IC chip 21 of the transponder 20 is disposed in the smooth region A between the ridges 30 adjacent to each other of the plurality of ridges 30. Here, not only the center C of the IC chip 21 but also the entire IC chip 21 is preferably in the smooth region A.

In the above-described pneumatic tire, the plurality of ridges 30 are formed at intervals on the tire inner surface Ts, the transponder 20 covered with the coating layer 23 made of rubber is embedded inside the tire, and a center position of the IC chip 21 constituting the transponder 20 is disposed in the region A between the adjacent ridges 30. Since the IC chip 21 is the thickest portion in the transponder 20, the IC chip 21 is particularly likely to be affected by the rubber flow around the transponder 20 during vulcanization. Therefore, an embodiment of the present technology can reduce, by disposing the center position of the IC chip 21 and the exhaust groove on the outer surface of the bladder in the green tire so that they do not overlap each other, the rubber flow of the coating layer 23 covering the transponder 20 during tire vulcanization, allowing the rubber of the coating layer 23 to sufficiently cover the entire transponder 20. This can prevent problems such as degradation of the communication performance of the transponder 20, leading to reduction of vulcanization defects of the tire.

On the other hand, if the center C of the IC chip 21 and the exhaust groove of the bladder are disposed so as to overlap each other, the rubber of the coating layer 23 may be affected by the rubber flowing into the exhaust groove of the bladder, failing to cover the entire transponder 20. That is, the IC chip 21 is exposed, the transponder 20 comes into contact with an adjacent rubber member, the resonant frequency is shifted, and the communication performance of the transponder 20 is degraded.

In the above-described pneumatic tire, a mutual distance d between the plurality of ridges 30 preferably ranges from 3 mm to 50 mm, more preferably ranges from 5 mm to 30 mm, and most preferably ranges from 8 mm to 15 mm. The mutual distance d is a distance between adjacent ridges 30 in a region directly above the embedded position of the transponder 20, and is measured in a direction orthogonal to an extending direction of the ridges 30. Appropriately setting the mutual distance d between the ridges 30 as described above while reducing the rubber flow of the coating layer 23 by devising an arrangement position of the transponder 20 can improve the effect of discharging air between the tire inner surface and the bladder during tire vulcanization. This leads to suppression of vulcanization defects of the tire. Here, the mutual distance d being less than 3 mm increases a region where the transponder 20 and the exhaust grooves of the bladder overlap and may cause the coating layer 23 to fail to sufficiently cover the entire transponder 20. On the other hand, the mutual distance d exceeding 50 mm cannot sufficiently obtain the effect of discharging air by the exhaust grooves of the bladder during vulcanization, causing vulcanization defects of the tire to be likely to occur. An average roughness Ra of the tire inner surface Ts is preferably 150 μm or less. The average roughness Ra is an arithmetic mean roughness measured in accordance with JIS (Japanese Industrial Standard) B0601.

An inclination angle θ (see FIG. 2A) of the ridge 30 with respect to a tire circumferential direction Tc preferably ranges from 20° to 60°. The inclination angle θ of the ridge 30 is an angle measured on the tire inner circumference in a position in the tire radial direction where the transponder 20 is disposed. Appropriately setting the inclination angle θ of the ridge 30 as described above while reducing the rubber flow of the coating layer 23 by devising the arrangement position of the transponder 20 can improve the effect of discharging air between the tire inner surface and the bladder during tire vulcanization. This leads to suppression of vulcanization defects of the tire. Here, the inclination angle θ being less than 20° cannot sufficiently obtain the effect of discharging air by the exhaust groove of the bladder during vulcanization. In contrast, the inclination angle θ being more than 60° causes air to easily accumulate between the tire inner surface and the bladder during vulcanization, causing vulcanization defects of the tire to be likely to occur.

An average rubber thickness Ti (mm) from the tire inner surface Ts to a carcass cord 41 constituting the carcass layer 4 (see FIG. 2B) and a height Tb (mm) of the ridge 30 (see FIG. 2B) preferably satisfy the relationship 0.2≤Tb/Ti≤3.0 and more preferably satisfy the relationship 0.5≤Tb/Ti≤1.0. The average rubber thickness Ti and the height Tb of the ridge 30 are a thickness and a height measured on the tire inner circumference in a position in the tire radial direction where the transponder 20 is disposed. Appropriately setting the ratio Tb/Ti as described above while reducing the rubber flow of the coating layer 23 by devising the arrangement position of the transponder 20 can improve the effect of discharging air between the tire inner surface and the bladder during tire vulcanization. This leads to suppression of vulcanization defects of the tire. It should be noted that the average rubber thickness Ti is a rubber thickness including the innerliner layer 9 and coating rubber covering the carcass cords 41 without including the ridges 30.

Here, the ratio Tb/Ti being less than 0.2 may decrease the height Tb of the ridge 30 but increase the thickness of the innerliner layer 9. This causes air accumulated at a step such as a splice portion of tire components during vulcanization to be unlikely to escape, causing vulcanization defects of the tire to be likely to occur. On the other hand, if the ratio Tb/Ti exceeds 3.0, it is assumed that the thickness of the innerliner layer 9 is excessively thin with respect to the height Tb of the ridge 30. Therefore, the rubber flow tends to deteriorate in the entire tire during vulcanization, which is not preferable.

Further, the height Tb of the ridge 30 preferably ranges from 0.3 mm to 1.5 mm. Appropriately setting the height Tb of the ridge 30 as described above while reducing the rubber flow of the coating layer 23 by devising the arrangement position of the transponder 20 can improve the effect of discharging air between the tire inner surface and the bladder during tire vulcanization. This leads to suppression of vulcanization defects of the tire.

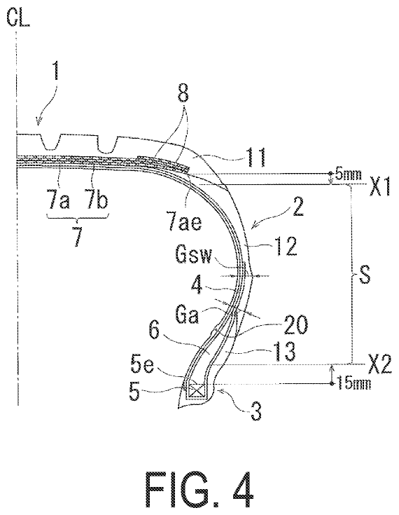

The pneumatic tire described above includes the transponder 20 embedded on an outer side in the tire width direction of the carcass layer 4. When the transponder 20 is disposed in the sidewall portion 2 in this manner, the transponder 20 is preferably disposed, as a placement region in the tire radial direction, between a position X1 5 mm inner side in the tire radial direction from an end 7ae of the belt layer 7 having the widest belt width of the plurality of belt layers 7 (a belt layer 7a on the inner side in the tire radial direction in FIG. 4) and a position X2 15 mm outer side in the tire radial direction from an upper end 5e of the bead core 5 (an end portion on the outer side in the tire radial direction). In other words, the transponder 20 is preferably disposed in a region S illustrated in FIG. 4. In particular, the transponder 20 is preferably disposed separated from the upper end 5e of the bead core 5 by the 20 mm or more to the outer side in the tire radial direction because the transponder 20 is not affected by a rim flange.

Furthermore, when the transponder 20 is disposed in the sidewall portion 2, the transponder 20 is preferably embedded in, as a placement region in the tire width direction, a position where a total thickness Ga of the sidewall portion 2 is in a range from 60% to 300% of a total thickness Gsw of the sidewall portion 2 at a tire maximum width position. In other words, as long as this thickness range is satisfied, the transponder 20 can be disposed in a center of the sidewall rubber layer 12 or the rim cushion rubber layer 13, or the like.

The total thickness Ga and the total thickness Gsw are both thicknesses measured along a normal line direction of the carcass layer 4 (carcass line). The position of the end of the belt layer, the tire maximum width position, and the position of the upper end of the bead core are positions specified when a tire having an air pressure of 180 kPa is mounted on a standard rim defined by JATMA (the Japan Automobile Tyre Manufacturers Association, Inc.) and is in an unloaded state.

When the transponder 20 is disposed in the sidewall portion 2, disposing the transponder 20 so as to fill both the above-mentioned placement regions in the tire radial direction and the tire width direction causes the transponder 20 to be positioned separated from the tire components made of metal (for example, the bead core 5, the rim, or the like). This causes metal interference to be unlikely to occur and allows the communication performance of the transponder 20 to be sufficiently ensured.

In a case where the transponder 20 is disposed in the sidewall portion 2 as described above, a total thickness Gac of the coating layer 23 preferably ranges from 1% to 30%, more preferably ranges from 5% to 25%, and most preferably ranges from 10% to 17% of a tire total thickness Gt at the embedded position of the transponder 20. Appropriately setting the total thickness Gac of the coating layer 23 with respect to the tire total thickness Gt as described above can effectively reduce the rubber flow of the coating layer 23 during tire vulcanization. The tire total thickness Gt is a thickness measured along the normal line direction of the carcass layer 4 (carcass line) at the embedded position of the transponder 20.

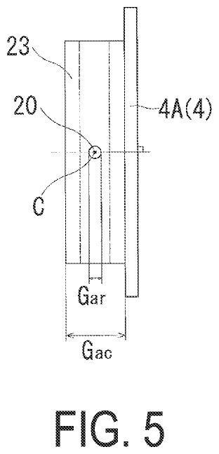

In the pneumatic tire described above, the total thickness Gac of the coating layer 23 and a maximum thickness Gar of the transponder 20 preferably satisfy the relationship 1.1≤Gac/Gar≤3.0. Here, the total thickness Gac of the coating layer 23 is the total thickness of the coating layer 23 at a position including the transponder 20, and is, for example, as illustrated in FIG. 5, the total thickness on a straight line passing through the center C of the transponder 20 (IC chip 21) and perpendicularly intersecting the closest carcass cord of the carcass layer 4 in a tire meridian cross-section. The total thickness Gac of the coating layer 23 preferably ranges from 1.0 mm to 3.0 mm. The total thickness Gac of the coating layer 23 and the maximum thickness Gar of the transponder 20 satisfying the above-described relationship allows the total thickness Gac of the coating layer 23 to be sufficiently ensured, allowing the rubber flow of the coating layer 23 during tire vulcanization to be effectively reduced.

Here, the aforementioned ratio being excessively small (the total thickness Gac of the coating layer 23 being excessively thin) causes the transponder 20 to contact the adjacent rubber member, causes a resonant frequency to be shifted, and tends to degrade the communication performance of the transponder 20. On the other hand, the aforementioned ratio being excessively large (the total thickness Gac of the coating layer 23 being excessively thick) tends to degrade tire uniformity and balance.

The coating layer 23 preferably contains 20 phr or less of carbon black. Furthermore, the coating layer 23 more preferably contains 3 phr or more of carbon black. When the coating layer 23 contains a specific amount of carbon black as described above, the relative dielectric constant of the coating layer 23 can be reduced, thereby improving the communication performance of the transponder 20. The “phr” as used herein means parts by weight per 100 parts by weight of the rubber component (elastomer).

Furthermore, a viscosity v1 of the coating layer 23 and a viscosity v2 of a rubber member disposed adjacent to the coating layer 23 on the inner side in the tire width direction preferably satisfy the relationship 0.5<v1/v2<1.5. Examples of the adjacent rubber member include the innerliner layer 9 and adhesive tie rubber. Appropriately setting the ratio v1/v2 between the viscosity v1 of the coating layer 23 and the viscosity v2 of the adjacent rubber member as described above can effectively reduce the rubber flow of the coating layer 23 during tire vulcanization and obtain a further effect of suppressing vulcanization defects. The viscosity v1 of the coating layer 23 and the viscosity v2 of the adjacent rubber member are Mooney viscosities [ML (1+4) 100° C.] and measured in accordance with JIS K6300-1, by a Mooney viscometer using an L-shaped rotor, and under conditions of preheating time of 1 minute, rotation time of rotor of 4 minutes, and test temperature of 100° C.

Here, the ratio v1/v2 being less than 0.5 causes the coating layer 23 to easily flow during vulcanization. This exposes the transponder 20 and tends to degrade the communication performance of the transponder 20. On the other hand, if the ratio v1/v2 exceeds 1.5, the bladder is pressed against a member on the outer side in the tire axial direction by an external force from the bladder during vulcanization, making vulcanization defects more likely to occur. For example, if the transponder 20 is disposed between the innerliner layer 9 and the carcass layer 4, the vulcanization defects may be a crack or the like in the innerliner layer 9.

Further, the coating layer 23 preferably has a relative dielectric constant of 7 or less and more preferably from 2 to 5. The relative dielectric constant of the coating layer 23 is preferably set lower than relative dielectric constants of the rubber members disposed adjacent to the coating layer 23. Setting the relative dielectric constant of the coating layer 23 in this manner allows radio wave transmittivity when the transponder 20 emits a radio wave to be ensured, effectively improving the communication performance of the transponder 20. The rubber constituting the coating layer 23 has a relative dielectric constant of from 860 MHz to 960 MHz at ambient temperature. Here, the ambient temperature is 23±2° C. and 60%±5% RH (relative humidity) in accordance with the standard conditions of the JIS standard. The relative dielectric constant of the rubber is measured by the capacitance method after the rubber is treated at 23° C. and 60% RH for 24 hours. The range of from 860 MHz to 960 MHz described above corresponds to currently allocated frequencies of the RFID in a UHF (ultra high frequency) band, but in a case where the allocated frequencies are changed, the relative dielectric constant in the range of the allocated frequencies may be specified as described above.

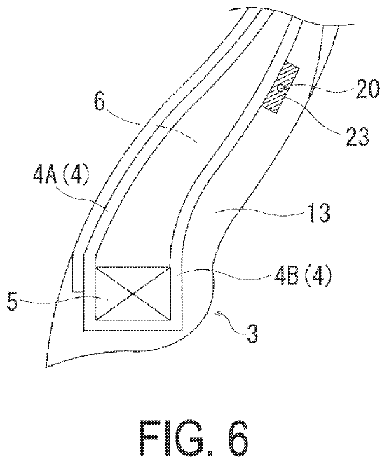

FIG. 6 illustrates a modified example of a pneumatic tire according to an embodiment of the present technology. In FIG. 6, components that are identical to those in FIG. 1 have the same reference sign, and detailed descriptions of those components have been omitted.

As illustrated in FIG. 6, the transponder 20 is disposed on the outer side of a body portion 4A of the carcass layer 4 in the tire width direction. That is, the transponder 20 can be disposed between the carcass layer 4 and the bead filler 6, the sidewall rubber layer 12, or the rim cushion rubber layer 13. When the transponder 20 is disposed on the outer side of the body portion 4A of the carcass layer 4 in the tire width direction, as the rubber member disposed adjacent to the coating layer 23, coating rubber of the carcass layer 4, the bead filler 6, the sidewall rubber layer 12, and the rim cushion rubber layer 13 are exemplified. Further, as a rubber member adjacent to the coating layer 23 on the inner side in the tire width direction, coating rubber of the carcass layer 4, the bead filler 6, the sidewall rubber layer 12, the rim cushion rubber layer 13, and filler rubber that can be additionally disposed on the outer side of the bead filler 6 in the tire width direction, and coating rubber of a steel reinforcing layer are exemplified.

### EXAMPLES

Tires according to Conventional Example, Comparative Example, and Examples 1 to 10 were manufactured. The tires have a tire size of 245/35R21 and include a plurality of ridges formed at intervals on a tire inner surface and a transponder covered with a coating layer made of rubber and embedded inside the tire. For the tires, a tag arrangement in a region between the ridges on the tire inner surface, a mutual distance d of the ridges on the tire inner surface, an inclination angle θ of the ridge, a ratio Tb/Ti, a height Tb of the ridge, a ratio Gac/Gar, and a ratio Gac/Gt×100 are set in Table 1.

For these test tires, the communication performance of the transponder was evaluated using a test method described below, and the results are also indicated in Table 1.

### Communication Performance:

For each test tire, a communication operation with the transponder was performed using a reader/writer. Specifically, the maximum communication distance was measured with the reader/writer at a power output of 250 mW and a carrier frequency of from 860 MHz to 960 MHz. Evaluation results are expressed as index values with the value of the Conventional Example being defined as 100. Larger index values indicate superior communication performance.

TABLE 1-1

| | Conventional | Example | Example | Example | Example |
|---|---|---|---|---|---|
| | Example | 1 | 2 | 3 | 4 |
| Tag placement in region | No | Yes | Yes | Yes | Yes |
| between ridges on tire | | | | | |
| inner surface | | | | | |
| Mutual distance d | 2 | 2 | 3 | 50 | 35 |
| between ridges on tire | | | | | |
| inner surface (mm) | | | | | |
| Inclination angle 0 of | 10° | 10° | 10° | 10° | 30° |
| ridge | | | | | |
| Ratio Tb/Ti | 0.1 | 0.1 | 0.1 | 0.1 | 0.1 |
| Height of ridge Tb (mm) | 0.2 | 0.2 | 0.2 | 0.2 | 0.2 |
| Ratio Gac/Gar | 1.0 | 1.0 | 1.0 | 1.0 | 1.0 |
| Ratio Gac/Gt × 100 (%) | 0.5 | 0.5 | 0.5 | 0.5 | 0.5 |
| Communication | 100 | 102 | 104 | 105 | 106 |
| performance | | | | | |

TABLE 1-2

| | Example | Example | Example | Example | Example | Example |
|---|---|---|---|---|---|---|
| | 5 | 6 | 7 | 8 | 9 | 10 |
| Tag placement in region | Yes | Yes | Yes | Yes | Yes | Yes |
| between ridges on tire | | | | | | |
| inner surface | | | | | | |
| Mutual distance d | 35 | 35 | 35 | 35 | 35 | 35 |
| between ridges on tire | | | | | | |
| inner surface (mm) | | | | | | |
| Inclination angle θ of | 30° | 30° | 30° | 30° | 30° | 30° |
| ridge | | | | | | |
| Ratio Tb/Ti | 0.8 | 0.8 | 0.8 | 0.8 | 0.8 | 0.8 |
| Height of ridge Tb (mm) | 0.2 | 1.0 | 1.0 | 1.0 | 1.0 | 1.0 |
| Ratio Gac/Gar | 1.0 | 1.0 | 1.1 | 3.0 | 2.0 | 2.0 |
| Ratio Gac/Gt × 100 (%) | 0.5 | 0.5 | 0.5 | 0.5 | 1 | 30 |
| Communication | 107 | 108 | 109 | 111 | 112 | 115 |
| performance | | | | | | |

As can be seen from Table 1, compared with Conventional Example, the tires of Examples 1 to 10 were able to improve the communication performance of the transponder. That is, in Examples 1 to 10, the rubber flow of the coating layer was reduced, and the entire transponder was sufficiently covered with the coating layer, leading to an improvement in communication performance.

1. A tire, comprising:
a tread portion extending in a tire circumferential direction and having an annular shape;
a pair of sidewall portions respectively disposed on both sides of the tread portion;
a pair of bead portions each disposed on an inner side of the sidewall portions in a tire radial direction;
a carcass layer mounted between the pair of bead portions;
a plurality of belt layers disposed on an outer circumferential side of the carcass layer in the tread portion; and
an innerliner layer disposed on a tire inner surface along the carcass layer;
a plurality of ridges being formed at intervals on the tire inner surface,
a transponder covered with a coating layer made of rubber being embedded inside the tire, and
a center position of an IC chip constituting the transponder being disposed in a region between the ridges adjacent to each other.

2. The tire according to claim 1, wherein a mutual distance between the plurality of ridges ranges from 3 mm to 50 mm.

3. The tire according to claim 1, wherein on a tire inner circumference in a position in a tire radial direction where the transponder is disposed, an inclination angle θ of the ridges with respect to a tire circumferential direction ranges from 200 to 600.

4. The tire according to claim 1, wherein on a tire inner circumference in a position in a tire radial direction where the transponder is disposed, an average rubber thickness Ti from the tire inner surface to a carcass cord constituting the carcass layer and a height Tb of the ridges satisfy a relationship 0.2≤Tb/Ti≤3.0.

5. The tire according to claim 1, wherein a height Tb of the ridges ranges from 0.3 mm to 1.5 mm.

6. The tire according to claim 1, wherein
the transponder is embedded between a position 5 mm inner side in the tire radial direction from an end of a belt layer having the widest belt width of the plurality of belt layers and a position 15 mm outer side in the tire radial direction from an upper end of a bead core of the bead portion and in a position where a total thickness Ga of the sidewall portion measured along a normal line direction of the carcass layer is in a range from 60% to 300% of a total thickness Gsw of the sidewall portion at a tire maximum width position.

7. The tire according to claim 1, wherein the transponder is disposed between the innerliner layer and the carcass layer.

8. The tire according to claim 1, wherein a total thickness Gac of the coating layer and a maximum thickness Gar of the transponder satisfy a relationship 1.1≤Gac/Gar≤3.0.

9. The tire according to claim 6, wherein a total thickness Gac of the coating layer ranges from 1% to 30% of a tire total thickness Gt at an embedded position of the transponder.

10. The tire according to claim 1, wherein the coating layer contains 20 phr or less of carbon black.

11. The tire according to claim 1, wherein a viscosity v1 of the coating layer and a viscosity v2 of a rubber member disposed adjacent to the coating layer on an inner side in the tire width direction satisfy a relationship 0.5<v1/v2<1.5.

12. A method for manufacturing a tire, comprising:
forming a green tire in which a transponder covered with rubber is embedded between tire components;
vulcanizing the green tire by using a bladder comprising a plurality of exhaust grooves on an outer surface thereof, and
causing a plurality of ridges to be formed on an inner surface of the green tire by the bladder;
the method comprising, in embedding the transponder, embedding the transponder in the green tire such that a center position of an IC chip constituting the transponder is disposed in a region between the ridges adjacent to each other of the plurality of ridges.
